(19) United States
(12) Patent Application Publication
(10) Pub. No.: US 2006/0092536 A1
(43) Pub. Date: May 4, 2006

(54) Transfer method, apparatus and method of inspecting master disk

(75) Inventor: Yoichi Hayashi, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD

(21) Appl. No.: 11/256,148

(22) Filed: Oct. 24, 2005

(30) Foreign Application Priority Data
Oct. 29, 2004 (JP) 2004-316852
Oct. 29, 2004 (JP) 2004-316855

(51) Int. Cl. G11B 5/86

(52) U.S. Cl. 360/17

(57) ABSTRACT

The present invention provides a transfer apparatus comprising: a disk holding device which holds a master disk having many protruding patterns formed on the surface thereof by a holder section; a transfer device which transfers a pattern of the master disk to a slave disk; and an inspection device which causes a light irradiation device to irradiate irradiation light in such a way that the optical axis of the irradiation light forms an angle of 0 to 30 degrees with respect to a radial direction in parts to be inspected on the surface of the master disk, causes an image pickup element to take images of reflected light of the light irradiated and inspects a contamination condition on the surface of the master disk.

### BACKGROUND OF THE INVENTION

1. Field of the Invention

The present invention relates to a transfer method, apparatus and a method of inspecting a master disk, and more particularly, to a transfer method, apparatus and a method of inspecting a master disk effective for preventing defective products when transferring a magnetic information pattern such as format information from a master disk to a magnetic disk used for a hard disk drive or the like.

2. Description of the Related Art

In a magnetic disk (hard disk) used for a hard disk drive which is rapidly becoming widespread in recent years, it is a general practice that format information and address information are written into the magnetic disk after being delivered from a magnetic disk manufacturer to a drive manufacturer and before being incorporated in the drive. Though this writing can be performed from a magnetic head, a method of collectively transferring such format information and address information from a master disk in which such information is written is efficient and preferable.

Conventionally, there are various proposals of this type of magnetic transfer technique (e.g., see Japanese Patent Application Laid-Open No.2004-87099, Japanese Patent Application Laid-Open No.2002-74655, Japanese Patent Application Laid-Open No.2002-372501, Japanese Patent Application Laid-Open No.2002-334430). Of these documents, Japanese Patent Application Laid-Open No.2004-87099 proposes to improve work efficiency when conducting a magnetic transfer while automatically carrying a slave disk, both sides of which are in close contact with master disks. Japanese Patent Application Laid-Open No.2002-74655 proposes to form a servo area of a master disk into a shape more convex than a data area and thereby prevent defects such as missing of transfer signals.

However, problems are pointed out in such conventional techniques; for example, transfer defects often occur, transfer yields are low, or the master disk frequently needs to be replaced.

That is, when a magnetic transfer is carried out, a master disk and a transfer target hard disk (slave disk) must be brought into close contact, but when the level of cleanliness is poor in this environment, transfer defects may often occur or the surface of the master disk may be damaged due to particles and dust or the like.

Especially, with such repeated use of a master disk, dust, flocks and hards or the like in the surrounding environment are likely to stick to the surface of the master disk. When the master disk is brought into close contact with the slave disk with foreign matters such as dust, flocks and hards stuck to the surface of the master disk, the contact between the master disk and slave disk becomes insufficient within a predetermined range centered on the foreign matters, which is likely to result in transfer defects. When the recorded signal is a servo signal, there is a problem that the tracking function is not fully obtained and reliability deteriorates.

Furthermore, repeating close contact between the master disk and slave disk increases the strength of adhesion of the foreign matters to the surface of the master disk and increases the likelihood that similar transfer defects may be reproduced in subsequent close-contact transfers.

Furthermore, the adhesion of the above described foreign matters to the surface of the master disk also produces problems like deforming the surface of the master disk, damaging the surface of the master disk or hampering the normal function of the master disk or the like.

In contrast, there is a proposal such as Japanese Patent Application Laid-Open No.2002-372501 of a method of inspecting foreign matters from an image obtained by irradiating an inspection region with a laser beam and capturing reflected light through rotary scanning of a line sensor, whereby in the stage of image processing on the image captured in execution of the inspection of foreign matters, pattern grooves are registered beforehand in an image processing unit as a mask area and this area is masked so as to be distinguished from original convex defective parts due to the foreign matters.

Furthermore, there is also a proposal such as Japanese Patent Application Laid-Open No.2002-334430 of inspecting a slave disk before carrying out a magnetic transfer, not carrying out any magnetic transfer of the slave disk from which contamination has been discovered and thereby preventing contamination of the master disk.

### SUMMARY OF THE INVENTION

However, according to the inspection based on a laser scattering system such as Japanese Patent Application Laid-Open No.2002-372501, when there are projections and depressions such as a pattern section, the pattern section reflects light as with foreign matters and it is difficult to distinguish between the pattern section and foreign matter defects. Furthermore, the pattern section cannot help but be masked and so it is not possible to inspect the servo area which is most important in terms of quality. Furthermore, there is a problem that since the convex section of the pattern section is formed to be higher than a data area, that section is easily affected.

Furthermore, the inspection as described in Japanese Patent Application Laid-Open No.2002-334430 has a problem that it is not possible to inspect an end face of a slave disk which is particularly vulnerable to contamination and the inspection is not proved to be effective.

The present invention has been implemented in view of the above described circumstances and it is an object of the present invention to provide a transfer method, apparatus and a method of inspecting a master disk capable of easily identifying foreign matters such as dust, flocks and hards from the master disk, easily removing the foreign matters accordingly and thereby drastically improving the service life of the master disk and improving productivity of the close-contact transfer work.

Furthermore, it is another object of the present invention to provide a magnetic transfer apparatus and method capable of easily identifying foreign matters such as dust, flocks and hards on the surface and end face of a slave disk, drastically improving the service life of the master disk by not performing any magnetic transfer of the contaminated slave disk and improving productivity of the close-contact transfer work.

In order to attain the above described objects, the present invention provides a transfer apparatus including a disk holding device which holds a master disk having many protruding patterns formed on the surface thereof by a holder section, a transfer device which transfers a pattern of the master disk to a slave disk and an inspection device which causes a light irradiation device to irradiate irradiation light in such a way that the optical axis of the irradiation light forms an angle of 0 to 30 degrees with respect to a radial direction in parts to be inspected on the surface of the master disk, causes an image pickup element to take images of reflected light of the light irradiated and inspects a contamination condition on the surface of the master disk.

According to the present invention, the inspection device which inspects the contamination condition of the surface of the master disk irradiates irradiation light in such a way that the optical axis forms an angle of 0 to 30 degrees with respect to the radial direction of parts to be inspected of the surface of the master disk and takes an image of reflected light of the irradiated light. This makes it possible to detect with high sensitivity foreign matters on specific patterns which give adverse influences on quality most while reducing reflected light from the specific patterns on the master disk which can be easily mistaken for original foreign matters.

Note that the “angle of 0 to 30 degrees with respect to the radial direction of parts to be inspected of the surface of the disk” includes an angle of inclination with respect to the surface (plane) of the disk as well as an angle of inclination with respect to the radius of the surface (plane) of the disk and means that the total angle of inclination with respect to a radius line virtually drawn on the parts to be inspected of the surface of the disk is not less than 0 degrees and not more than 30 degrees.

Furthermore, it seems that if the angle of inclination of the optical axis is 0 degrees, the parts to be inspected may not be irradiated, but since a light beam from the light irradiation device has a predetermined sectional size, the parts to be inspected can be effectively irradiated.

Furthermore, the present invention provides a transfer method including a supply step of supplying a slave disk in such a way as to face a master disk held in a holder section with many protruding magnetic layer patterns formed on the surface thereof; a pressure contacting step of pressure-contacting the supplied slave disk interposed between the master disks; a transfer step of applying a magnetic field to the holder section and transferring magnetic patterns on the master disk to the slave disk; and an inspection step of causing a light irradiation device to irradiate irradiation light in such a way that the optical axis of the irradiation light forms an angle of 0 to 30 degrees with respect to a radial direction in parts to be inspected on the surface of the master disk, causing an image pickup element to take images of reflected light of the light irradiated and inspecting a contamination condition on the surface of the master disk.

Furthermore, the present invention provides a transfer apparatus including a disk holding device which holds a master disk having many protruding magnetic layer patterns formed on the surface thereof by a holder section; a magnetic field application device which applies a magnetic field to the holder section and transfers a magnetic pattern of the master disk to a slave disk; and an inspection device which causes a light irradiation device to irradiate irradiation light in such a way that the optical axis of the irradiation light forms an angle of 0 to 30 degrees with respect to a radial direction in parts to be inspected on the surface of the master disk, causes an image pickup element to take images of reflected light of the light irradiated and inspects a contamination condition on the surface of the master disk.

According to the present invention, the inspection device which inspects the contamination condition of the surface of the master disk irradiates irradiation light in such a way that the optical axis forms an angle of 0 to 30 degrees with respect to the radial direction of parts to be inspected of the surface of the master disk and takes an image of reflected light of the irradiated light using the image pickup element. This makes it possible to detect with high sensitivity foreign matters on specific patterns which give adverse influences on quality most while reducing reflected light from the specific patterns on the master disk which can be easily mistaken for original foreign matters.

Note that the slave disk refers not only to a magnetic disk but also to various types of media such as optical disk (also including magneto-optical disk).

Furthermore, in order to attain the above described objects, the present invention provides a transfer apparatus including a transfer device which transfers patterns of a master disk to a slave disk and an inspection device which inspects a contamination condition on the surface and end face of the slave disk.

According to the present invention, the contamination condition on the surface and end face of the slave disk is inspected, and therefore it is possible to easily identify foreign matters such as dust, flocks and hards on the surface and end face of the slave disk, prevent any transfer to the contaminated slave disk, thereby prevent contamination of the master disk and drastically improve the service life of the master disk and improve productivity of the transfer work.

Furthermore, the present invention provides a transfer method including an inspection step of inspecting a contamination condition of the surface and end face of a slave disk, a selection step of selecting the slave disk into rank A and rank B based on the inspection result in the inspection step, a supply step of supplying the slave disk of rank A in such a way as to face the master disk held in a holder section and having magnetic patterns, a pressure contacting step of pressure-contact the supplied slave disk interposed between the master disks, a transfer step of applying a magnetic field to the holder section and transferring magnetic patterns on the master disk to the slave disk and a reproduction step of cleaning or discarding the slave disk of rank B.

Furthermore, to this effect, the present invention provides a transfer apparatus including a disk holding device which holds a master disk having magnetic patterns by a holder section, an inspection device which inspects a contamination condition of the surface and end face of a slave disk, a supply device which supplies the slave disk in such a way so as to face the master disk held by the holder section and a magnetic field application device which applies a magnetic field to the holder section and transfers the magnetic patterns of the master disk to the slave disk.

According to the present invention, the contamination condition of the surface and end face of the slave disk is inspected, and therefore it is possible to easily identify foreign matters such as dust, flocks and hards of the surface and end face of the slave disk and prevent any magnetic transfer of the contaminated slave disk (rank B) accordingly, thus making it possible to prevent contamination of the master disk, drastically improve the service life of the master disk and improve productivity of the close-contact transfer work.

The present invention preferably includes a cleaning device which selectively cleans contaminated parts of the surface and/or end face of the slave disk inspected by the inspection device. Provision of such a cleaning device allows the slave disk to be used instead of being discarded and also allows productivity of the close-contact transfer work to be improved.

Furthermore, the present invention preferably includes a decision device which decides a contamination condition of the slave disk inspected by the inspection device and a selection device which selects, based on the decision result by the decision device, a first option of carrying out a magnetic transfer using the magnetic field application device, a second option of carrying out cleaning of the slave disk using the cleaning device and a third option of ejecting the slave disk out of the apparatus without passing through the magnetic field application device and/or the cleaning device.

Thus, if any one of the three options can be selected based on the decision result of the contamination condition of the slave disk, it is possible to further improve productivity of the close-contact transfer work.

Furthermore, according to the present invention, the inspection device preferably includes a surface inspection device which inspects a contamination condition of the surface of the slave disk and an end face inspection device which inspects a contamination condition at the end face of the slave disk.

It is possible to inspect a contamination condition of the surface and end face of the slave disk using one inspection device, but provision of inspection devices dedicated to the surface and end face of the slave disk respectively will make it possible to obtain high inspection accuracy.

As explained above, according to the present invention, it is possible to detect with high sensitivity foreign matters on specific patterns which give adverse influences to the quality most while reducing reflected light from the original specific patterns on the master disk which can be easily mistaken for foreign matters.

Furthermore, according to the present invention, the contamination condition of the surface and end face of the slave disk is inspected, and therefore it is possible to easily decide foreign matters such as dust, flocks and hards of the surface and end face of the slave disk and prevent any magnetic transfer of the contaminated slave disk accordingly and thereby prevent contamination of the master disk, drastically improve the service life of the master disk and improve productivity of the close-contact transfer work.

### BRIEF DESCRIPTION OF THE DRAWINGS

FIG. 1 is a partially exploded perspective view of a magnetic transfer apparatus according to the present invention;

FIG. 2 is a perspective view showing how a slave disk is mounted or unmounted in/from a disk cassette;

FIG. 3 is a sectional view showing the structure of a holder unit;

FIG. 4 is a perspective view showing a state of alignment between a master disk and a slave disk;

FIG. 5 is a perspective view showing a positional relationship between an inspection device and holder unit;

FIG. 6 is a front view showing positional relationship of FIG. 5;

FIG. 7 is a plan view showing positional relationship of FIG. 5;

FIG. 8 is a perspective view showing a positional relationship between a cleaning device and holder unit;

FIG. 9 is a flow chart illustrating a method of operating the magnetic transfer apparatus;

FIG. 10 is a partially exploded perspective view of the magnetic transfer apparatus according to the present invention;

FIG. 11 is a front view showing a positional relationship between a surface inspection device and slave disk;

FIG. 12 is a plan view showing the positional relationship between the surface inspection device and the slave disk;

FIG. 13 is a front view showing a positional relationship between an end face inspection device and the slave disk;

FIG. 14 is a flow chart illustrating an operation method of the magnetic transfer apparatus;

FIG. 15 is a partially enlarged sectional view of the inspection device;

FIGS. 16A and 16B show examples of an image taken by a CCD camera;

FIGS. 17A and 17B are images after binarizing the images in FIGS. 16A and 16B; and

FIGS. 18A and 18B illustrate the master disk used for an attachment inspection.

### DETAILED DESCRIPTION OF THE PREFERRED EMBODIMENTS

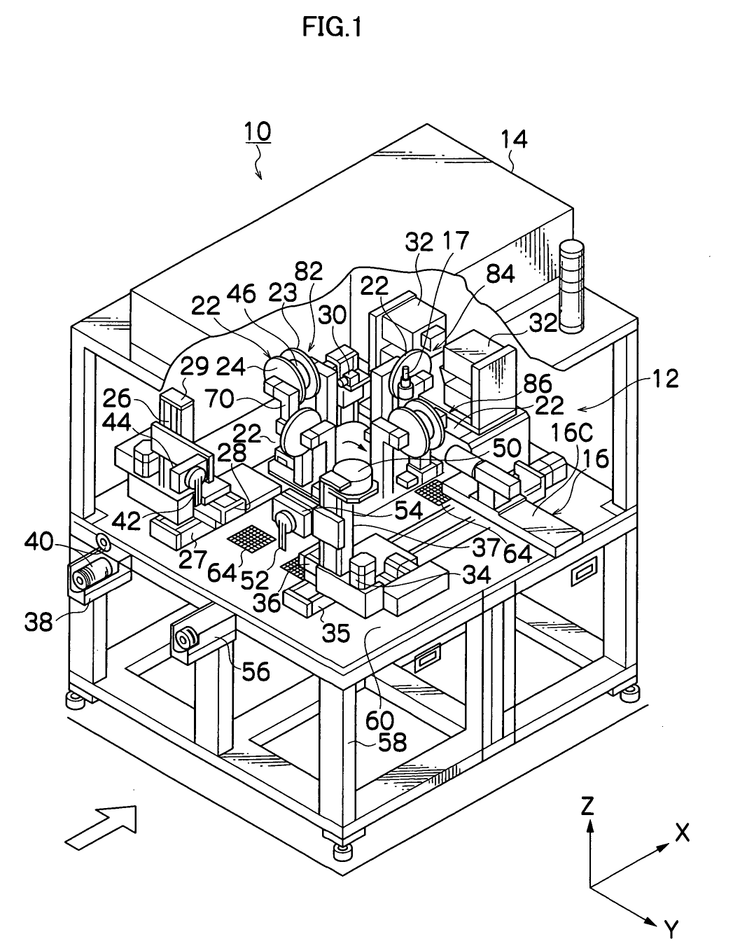

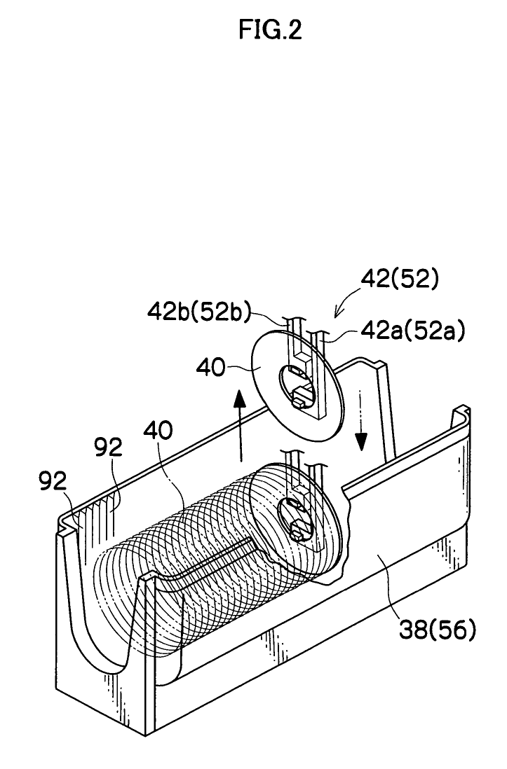

With reference now to the attached drawings, preferred embodiments of a transfer method, apparatus and a method of inspecting a master disk according to the present invention will be explained in detail below. FIG. 1 is a perspective view showing the overall structure of a magnetic transfer apparatus 10 which is a transfer apparatus according to the present invention. FIG. 2 is a perspective view showing an outline of a disk cassette. The magnetic transfer apparatus 10 is constructed of an apparatus body 12 and a clean unit 14.

The apparatus body 12 is provided with a frame 58 and this frame 58 is provided with a base 60 whose surface is oriented in horizontal direction. The side shown with a thick arrow is the front side of the apparatus body 12. This apparatus body 12 is covered with a clean unit 14 so as to secure cleanliness.

The ceiling section of the clean unit 14 is provided with a clean air feeding unit (not shown) which supplies clean air into the apparatus. This clean air feeding unit is constructed of an air filter such as HEPA filter or ULPA filter and air feeding fan so that clean air of cleanliness class less than 100 can be supplied through a down flow.

The clean air blown out of the clean air feeding unit is discharged out of the unit. For this reason, as shown in FIG. 1, a plurality of exhaust fans 64 are provided as exhaust devices in areas on the base 60 not occupied by the mechanisms of the apparatus body 12.

At the front end of the base 60 are a supply cassette 38 for housing slave disks 40, slave disks, and an ejection cassette 56 as a cassette for collecting those slave disks 40 which have been ejected with magnetic information transferred thereto. Cassettes of the same shape are used for the supply cassette 38 and ejection cassette 56.

As shown in FIG. 2, the supply cassette 38 and ejection cassette 56 are designed so as to be able to house a plurality of slave disks 40 one behind another. That is, the slave disks 40 can be inserted one by one with certain play into a plurality of grooves 92, 92 formed in parallel in the inner surface of the cassette so that the surfaces of the grooves 92 hold the circumferences of the slave disks 40 and the plurality of slave disks 40 are spaced from each other.

An index table 50 is attached substantially at the center of the top surface of the base 60 by means of a shaft perpendicular to the base 60 in a freely rotatable manner. On the index table 50 are four holder units 22 as holding devices which hold a pair of master disks 46 and one slave disk 40 uniformly (every 90 degrees) spaced in the rotation direction of the index table 50.

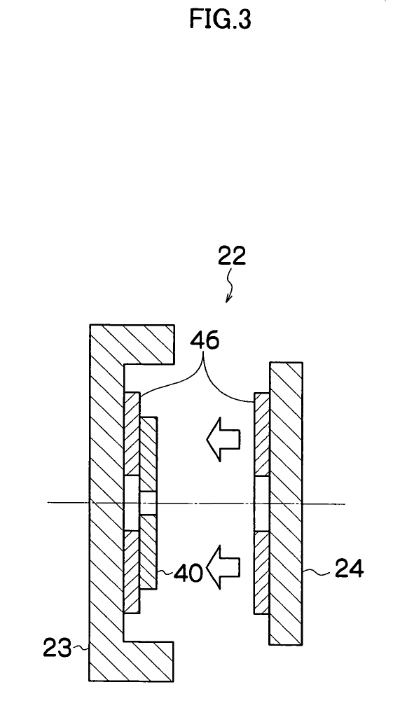

As shown in a sectional view of FIG. 3, the holder unit 22 is constructed of a fixed side holder 23 and a moving side holder 24 forming a pair of holder sections. The fixed side holder 23 and moving side holder 24 position, fix or hold each master disk 46 through an off-line setup or the like under suction or adhesion and at the same time hold the slave disk 40 under suction so that the slave disk 40 is interposed between the master disks 46, 46 in close contact therewith.

The fixed side holder 23 and moving side holder 24 fix the master disks 46, 46 which record information of different contents so as to correspond to magnetic information to be recorded on the respective principal surfaces of the slave disk 40. The slave disk 40 can be interposed between the pair of master disks 46, 46 with the respective principal surfaces of the slave disk 40 closely contacting the master disks 46, 46.

The fixed side holder 23 is a circular cup-shaped member enabling the master disk 46 to be fixed inside the cup. The moving side holder 24 is a disk-shaped member enabling the master disk 46 to be fixed to the surface thereof. The fixed side holder 23 is fixed to the apparatus body 12. On the other hand, the moving side holder 24 is fixed to the apparatus body 12 through a drive device (not shown) and made movable so as to approach or separate from the fixed side holder 23.

When the slave disk 40 is supplied or removed according to the above described structure of the holder unit 22, the fixed side holder 23 and moving side holder 24 are set at a predetermined distance from each other as shown in FIG. 3, facilitating the handling of the slave disk 40 by a disk supply unit 26 and disk ejection unit 34 which will be described later.

In the apparatus body 12 in FIG. 1, rotation of the index table 50 is driven intermittently by a drive motor (not shown), the respective holder units 22 are sequentially sent to and stopped at their respective step positions in such a way that the holder units 22 correspond to their respective positions calculated, which allows a plurality of operations to be performed simultaneously. The index table 50 is driven intermittently so that the four holder units 22 are always disposed at their four predetermined positions. That is, each holder unit 22 stops every time it moves 90 degrees.

Furthermore, the apparatus body 12 in FIG. 1 is provided with a disk supply unit 26 on one side (left side when viewed from the front in FIG. 1) of the top surface of the base 60 and a disk ejection unit 34 on the other side (right side when viewed from the front in FIG. 1) of the top surface of the base 60.

The disk supply unit 26 is a disk supply device capable of directly carrying each slave disk 40 from the supply cassette 38 to the holder unit 22 in which the master disks 46, 46 are mounted without handing it over to a different chuck mechanism along the way.

The disk ejection unit 34, to the contrary, is a disk ejection device capable of directly carrying the slave disk 40 for which a magnetic transfer operation has been completed to the ejection cassette 56 without handing it over to a different chuck mechanism along the way.

The slave disk 40 picked up by the disk supply unit 26 from the supply cassette 38 is positioned relative to the master disk 46 already mounted in the fixed side holder 23 of the holder unit 22, suctioned to a cavity provided in the master disk 46 by the holder unit 22, handed over and held thereto with the magnetic information recording surface of the master disk 46 closely contacting with the magnetic information transferred surface of the slave disk 40. A suction groove (not shown) for suctioning an area close to the inner diameter of the slave disk 40 is provided inside the fixed side holder 23 and the slave disk 40 is suctioned and held to this suction groove.

As shown in FIG. 2, the disk supply unit 26 is constructed of a chuck mechanism 42 made up of two holding pieces; chucks 42a, 42b for holding the inner diameter of the slave disk 40, X, Y, Z-axis robots 27, 28, 29 as shown in FIG. 1 and a rotary cylinder 44 having an axis of rotation in the Y-axis direction which rotates the chucks 42a, 42b so as to rotate the slave disk 40 by 180 degrees within the X-Z plane.

That is, the disk supply unit 26 causes the rotary cylinder 44 to rotate the chucks 42a, 42b which hold the inner diameter of the slave disk 40 by 180 degrees to reverse the orientation of the slave disk 40 and chuck 42.

The disk ejection unit 34 is a disk unmounting device which receives, after the holder unit 22 is opened, the slave disk 40 subjected to a magnetic transfer, directly carries the disk to the ejection cassette 56 for storage therein.

The disk ejection unit 34 is constructed of a chuck mechanism 52 made up of two holding pieces; chucks 52a, 52b for holding the inner diameter of the slave disk 40, X, Y, Z-axis robots 35, 36, 37 and a rotary cylinder 54 having an axis of rotation in the X-axis direction which rotates the chucks 52a, 52b so as to rotate the slave disk 40 by 180 degrees within the Y-Z plane.

That is, the disk ejection unit 34 causes the rotary cylinder 54 to rotate the chucks 52a, 52b which hold the inner diameter of the slave disk 40 by 180 degrees to reverse the orientation of the slave disk 40 and a chuck 52.

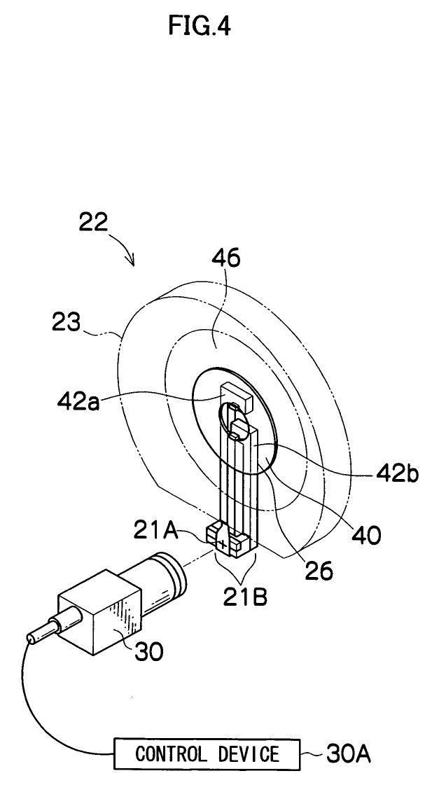

As shown in FIG. 4, a reference mark 21A is provided on an undersurface part of the fixed side holder 23 of the holder unit 22 beforehand and recognition marks 21B, 21B are affixed to the chucks 42a, 42b of the disk supply unit 26 beforehand. The reference mark 21A and recognition marks 21B, 21B are visually recognized by a recognition unit 30.

This recognition unit 30 is disposed at a position close to a side opposite to the side on which the supply cassette 38 is provided on the top surface of the base 60. When the slave disk 40 which has been carried by the disk supply unit 26 is positioned on the master disk 46, the recognition unit 30 visually recognizes the reference mark 21A and recognition marks 21B, 21B provided beforehand on the holder unit 22 and disk supply unit 26 respectively using a CCD camera or the like.

A control device 30A as a positioning device is connected to the recognition unit 30, and the control device 30A calculates the center of the master disk 46 from the recognized reference mark 21A and calculates the center of the slave disk 40 from the recognized recognition marks 21B, 21B. The control device 30A then drives and controls the robots 28, 29 of the Y and Z axes of the disk supply unit 26 so that the center of the master disk 46 matches the center of the slave disk 40.

The slave disk 40 which has been positioned is moved by the X-axis robot 27 of the disk supply unit 26 to a position at which it comes into close contact with the master disk 46 held inside the fixed side holder 23, suctioned and held to the inside of the fixed side holder 23.

At this time, the control device 30A is informed beforehand of the positional relationship between the reference mark 21A provided on the fixed side holder 23 and the center position of the master disk 46 held to the fixed side holder 23.

On the other hand, with regard to the relationship between the recognition marks 21B, 21B provided on the disk supply unit 26 and the center position of the slave disk 40, the control device 30A is informed beforehand of the relationship between the center position of the slave disk 40 and the recognition marks 21B, 21B assuming that the center of the slave disk 40 is located on a straight line connecting parts which the chucks 42a, 42b contact through the chucking operation of the chuck mechanism 42.

Based on these informed positional relationships, the positional relationship between the slave disk 40 and master disk 46 is calculated indirectly.

Coil units 32, 32 are disposed away from each other on both sides of the slave disk 40 interposed between the master disks 46, 46 which are fixed to the fixed side holder 23 and moving side holder 24 of the holder unit 22 respectively viewed from the direction in which the master disks 46, 46 and slave disk 40 overlap with each other when the holder unit 22 is closed. These coil units 32, 32 are intended to apply a magnetic field of predetermined intensity to promote magnetic transfer action on the master disks 46, 46 and slave disk 40.

Next, an inspection device which inspects a contamination condition on the surface of the master disks 46, 46 and a cleaning device which selectively cleans contaminated locations on the surfaces of the master disks 46, 46 inspected by this inspection device will be explained (first embodiment).

The inspection device and cleaning device are provided on the side of the holder unit 22 at a disk ejection step position 86 in FIG. 1. Of the inspection device, FIG. 1 only shows a CCD camera 16 which is an image pickup element and an illumination device 17 which is a light irradiation device, while the cleaning device is not shown because it is retracted to a side opposite to the holder unit 22 side.

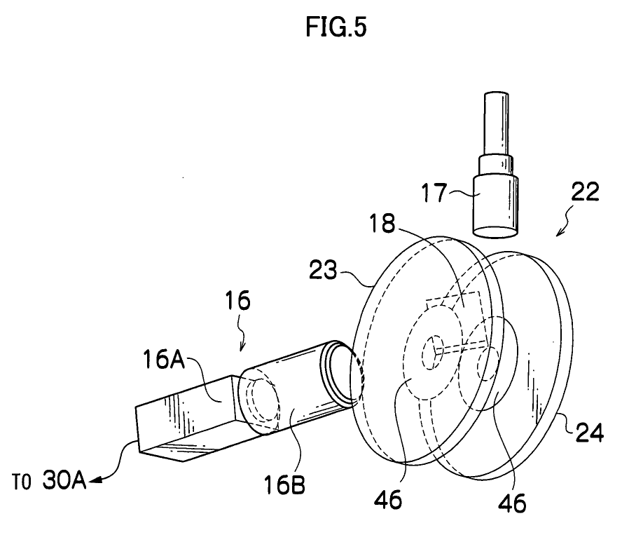

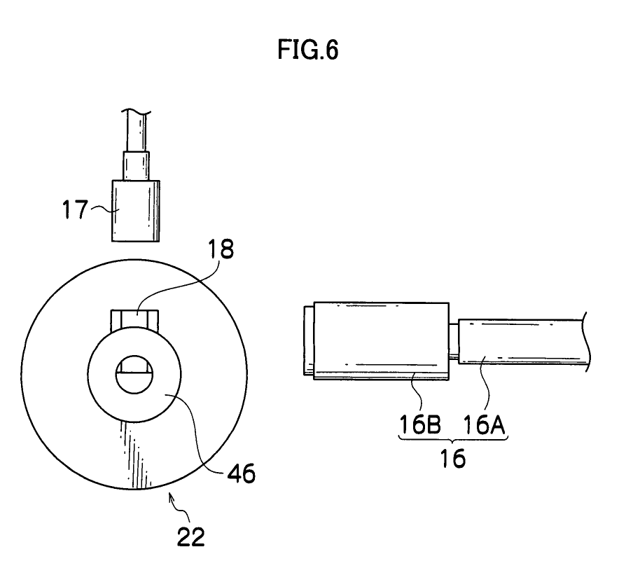

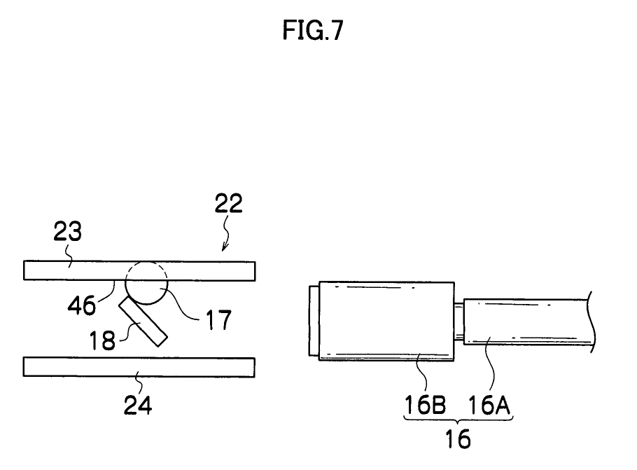

FIG. 5 is a perspective view showing a positional relationship between the inspection device and holder unit 22, FIG. 6 is a front view thereof and FIG. 7 is a plan view thereof. This inspection device is constructed of the CCD camera 16 which is an image pickup element, the illumination device 17 and a mirror 18. The CCD camera 16 is constructed of a camera body 16A and a lens barrel 16B. This CCD camera 16 is connected to the already described control device 30A.

The CCD camera 16 is supported by a support device 16C (see FIG. 1) and made slightly rotatable around the X-axis and Z-axis according to an instruction from the control device 30A so as to keep track of parts to be inspected of both the master disks 46, 46.

Moreover, the CCD camera 16 is made retractable so as not to interfere with the respective robots 35, 36, 37 of the disk ejection unit 34 when an inspection ends.

The resolution and brightness of the lens used for the lens barrel 16B of this CCD camera 16 are important. Therefore, when a high resolution lens of 0.5× to 2× is used for this lens, the resolution of the lens is preferably 10 μm or less or more preferably 5 μm or less.

In order to obtain brightness of this lens to detect diffused light of contamination (attachment) on the surface of the master disks 46, 46, the lens preferably has a large diameter; 8 in an F value is preferable and F6 or less is more preferable.

For the sensor section of the CCD camera 16, an area image sensor can also be used besides a line image sensor. In this case, the greater the sensitivity and the number of pixels of the sensor, the more it is possible to increase the detection sensitivity irrespective of the type of the sensor. In that sense, the pixel pitch of the sensor is preferably 10 μm or less or more preferably 5 μm or less. The number of pixels of the sensor is preferably 5000 to 8000 pixels for a line image sensor and a 6-million-pixel class is preferable for an area image sensor.

When the sensor section of the CCD camera 16 is a line image sensor, images are captured while rotating, but in the case of an area image sensor, it is necessary to stop rotation and capture images or capture still images using a high intensity stroboscope.

The illumination device 17 is intended to diagonally illuminate the master disk 46 to be inspected out of the master disks 46, 46 suctioned and held by the holder unit 22. As such an illumination device 17, a halogen light source can be preferably used. Especially when contamination on the surface of the master disks 46, 46 is micro attachment, a metal halide light source having greater green and blue components of wavelength of 600 nm or less can be preferably used.

The intensity of illumination light irradiated from the illumination device 17 is also important and intensity of 100,000 Lx is preferable. When the intensity of illumination light is 100,000 Lx or more, it is possible to detect attachment of submicron class.

Here, only one illumination device 17 is provided, but if two illumination devices 17 are provided so as to realize illumination from the opposite side on the same optical axis, it is possible to improve the intensity at parts to be inspected of the master disk 46 and also illuminate attachment which is hardly reflected with only illumination from one side, thus further improving detection sensitivity.

As a structure other than this, it is also possible to adopt a structure replacing the illumination device on the opposite side by a reflecting mirror. In this case, if light is condensed with the reflecting mirror such as a concave mirror, it is possible to illuminate parts to be inspected of the master disk 46 more efficiently.

When illumination from the illumination device 17 reaches the mirror 18 for image formation, that results in a noise component like flare, and therefore illumination light needs to be narrowed sufficiently by a lens or the like.

Furthermore, a high-intensity laser can also be used instead of a halogen light source as the illumination device 17. In this case, a laser having a shorter wavelength such as an argon laser or YAG double-frequency laser is preferable in terms of detection sensitivity.

Furthermore, for polarized light, use of S polarized light which is parallel to the surface of the inspected region is preferable because in this way pattern reflection is reduced. Polarized light has an effect of reducing pattern reflection even using a normal illumination device, but intensity may decrease and detection sensitivity may decrease unless the brightness of the illumination device is increased sufficiently. Likewise, the light-receiving lens of the CCD camera 16 may also be provided with a polarizing plate so as to allow only P polarized light generated during diffusion to pass. In such a case, it is also preferable to increase intensity of the light source as much as possible.

The illumination device 17 is supported by a support device (not shown) and slightly made rotatable around the X-axis and Y-axis according to an instruction from the control device 30A and designed so as to keep track of parts to be inspected of both the master disks 46, 46. Furthermore, the illumination device 17 is supported in such a way that the optical axis of thereof forms an angle of 0 to 30 degrees with respect to the radial direction of the parts to be inspected on the surface of the master disk 46.

The mirror 18 is interposed between the two master disks 46, 46 inside the holder unit 22 by a support device (not shown). This mirror 18 is placed inclined with respect to the surface of the master disk 46 and an image of the part to be inspected of the master disk 46 is disposed at a position at which it can be taken by the CCD camera 16 through the mirror 18.

Both surfaces of this mirror 18 is mirror finished and made slightly rotatable around the Z-axis according to an instruction from the control device 30A so as to keep track of parts to be inspected of both the master disks 46, 46.

Furthermore, the mirror 18 is made outward retractable from between the two master disks 46, 46 inside the holder unit 22 when an inspection ends.

The size of the mirror 18 is preferably a size appropriate to the lens used for the lens barrel 16B of the CCD camera 16 (equivalent to the lens diameter). Moreover, the mirror 18 is preferably a high precision surface reflecting mirror.

The surface accuracy of the mirror 18 is preferably a ¼ wavelength or less and more preferably 1/10 wavelength or less. If the holder unit 22 has a sufficient opening distance or has a structure whereby one-side is shiftable at a time or the like, it is preferably not to use the mirror 18.

The above described structure of the inspection device allows the surface of the master disk 46 including an uneven pattern created according to a magnetized pattern of a servo signal or the like of the master disk 46 to be inspected. Information on parts to be inspected of the master disk 46 whose images have been taken by the CCD camera 16 (defects (contamination) and positional information thereof) is stored in the above described control device 30A.

As the inspection device, in addition to the above described structure, it is possible to use various publicly known inspection methods such as a method of scanning the surface of the master disk 46 with a laser beam, capturing this reflected light using a photomultiplier or photodiode or the like and thereby inspecting dust based on a variation of reflected light or a method of irradiating the surface of the master disk 46 with halogen light or the like and capturing reflected light using a CMOS line image sensor, area image sensor or the like for inspection.

Note that the light irradiation device should be supported in such a way that the optical axis thereof forms an angle of 0 to 30 degrees with respect to the radial direction of parts to be inspected on the surface of the master disk 46 in this case, too.

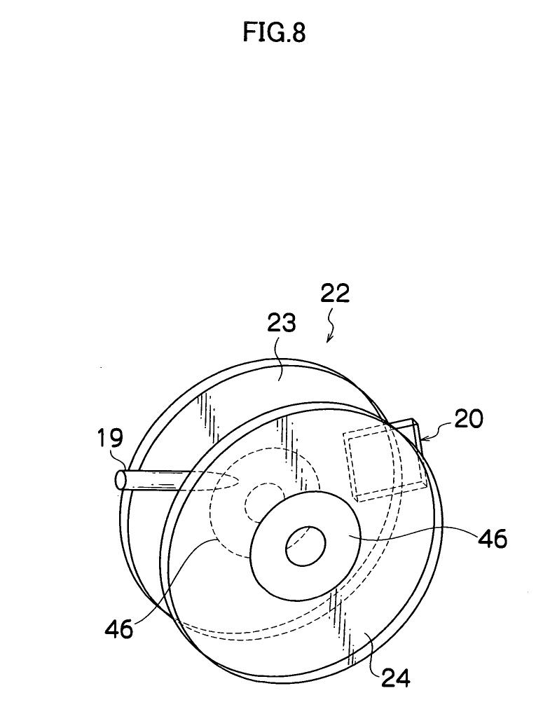

Next, the cleaning device will be explained. FIG. 8 is a perspective view showing a positional relationship between the cleaning device and holder unit 22. The cleaning device is made up of an air nozzle 19 and a suction nozzle 20.

The air nozzle 19 is a cylindrical member having a small diameter tip and is designed so as to spray a high-pressure jet flow from an air supply source (not shown) over parts to be cleaned of the master disk 46. That is, the air nozzle 19 is designed to be made movable to a position between the two master disks 46, 46 inside the holder unit 22 through a support device (not shown), and furthermore made slightly rotatable around the X-axis and Z-axis according to an instruction from the control device 30A so as to keep track of parts to be cleaned of both the master disks 46, 46.

The air nozzle 19 incorporates a filter (not shown) and an ultrasonic whistle, and can thereby jet clean air with vibration.

The suction nozzle 20 is a tubular member having a square and thin cross section and connected to a suction device (not shown). This suction nozzle 20 is made movable by a support device (not shown) to a position between the two master disks 46, 46 inside the holder unit 22 facing the air nozzle 19, and can thereby suction the air of a high-pressure jet flow sprayed over the air nozzle 19 and foreign matters on the master disk 46.

The above described structure of the cleaning device allows defects (contamination) on the master disk 46 to be selectively (locally) removed according to information (defects (contamination) and positional information thereof) on parts to be inspected stored in the control device 30A.

Besides the above described structure, it is also possible to adopt as the cleaning device various publicly known cleaning methods such as a device which sprays dry ice particles, a partial irradiation device of excimer laser, a structure which presses a cleaning roller or cleaning sheet having weak adhesion, a structure which wipes using a cleaning cloth or a burnishing device which brings a glide head close to the surface of the rotating master disk 46 or the like.

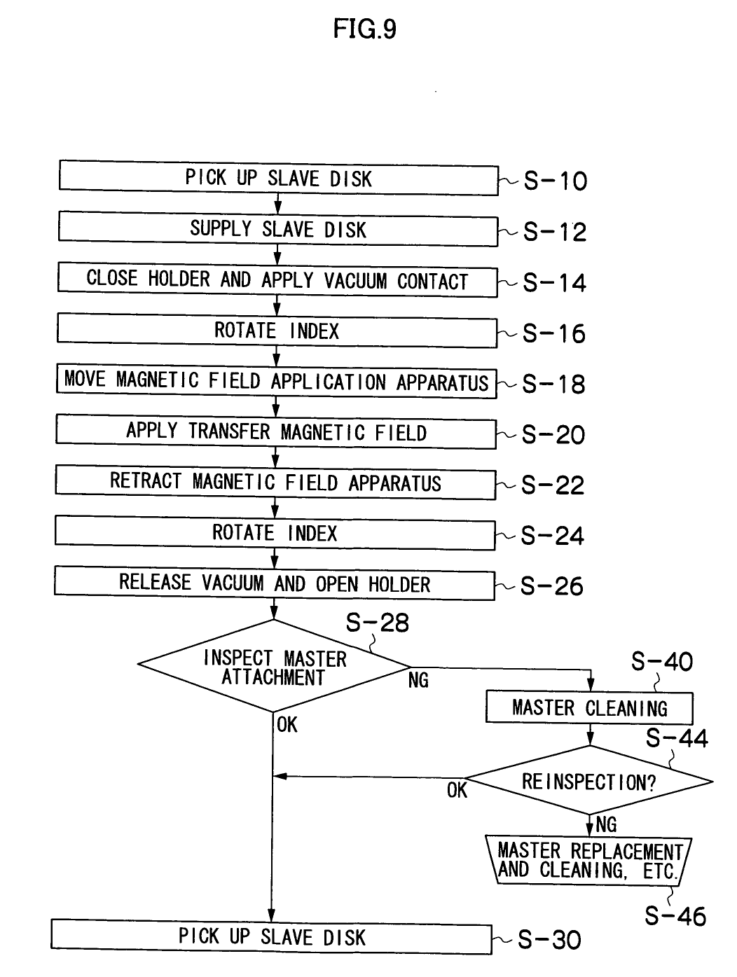

Next, the method of operating the magnetic transfer apparatus in the above described structure will be explained. FIG. 9 is a flow chart illustrating a method of operating the magnetic transfer apparatus.

After operation starts, the chuck mechanism 42 (chucks 42a, 42b) of the disk supply unit 26 holds the slave disk 40 in the supply cassette 38 and picks up the disks one by one (step S-10).

The slave disk 40 picked up is turned over within the Y-Z plane through the rotation of the rotary cylinder 44, moved by the X-axis robot 27 to an upper part of a gap between the master disks 46, 46 formed in the opened holder unit 22 located at a disk supply step position 82 in a direction perpendicular to the opening/closing direction of the holder unit 22 and inserted by the Y-axis robot 28 into the gap between the master disks 46, 46 (step S-12).

At this time, the respective master disks 46, 46 are accurately fixed at a position at which the center of the holder unit 22 matches the center of the master disk 46 under suction or adhesion inside the fixed side holder 23 and moving side holder 24 of the holder unit 22 according to an off-line setup or the like.

The center of the slave disk 40 supplied between the fixed side holder 23 and moving side holder 24 of the holder unit 22 substantially matches the center of the master disk 46 fixed to the inside of the fixed side holder 23 by the X, Y, Z-axis robots of the disk supply unit 26 and the slave disk 40 is moved to a recognition position at which the gap with respect to the master disk 46 becomes approximately 0.5 mm.

Next, the reference mark 21A provided on the undersurface of the fixed side holder 23 and the recognition marks 21B, 21B provided beforehand for the chuck mechanism 42 (chucks 42a, 42b) of the disk supply unit 26 are recognized by the recognition unit 30.

This recognition allows the Y, Z-axis robots 28, 29 of the disk supply unit 26 to position the slave disk 40 so that the center of the master disk 46 calculated from the reference mark 21A matches the center of the slave disk 40 calculated from the recognition marks 21B, 21B of the chuck mechanism 42.

Next, the slave disk 40 is moved by the X-axis robot 27 of the disk supply unit 26 to a position in close contact with the master disk 46 fixed to the inside of the fixed side holder 23 and suctioned and fixed to the inside of the fixed side holder 23.

Next, the moving side holder 24 is moved by a robot 70 toward the fixed side holder 23 so that both sides of the slave disk 40 are interposed between the two master disks 46, 46. In this way, both sides of the slave disk 40 are interposed between the two master disks 46, 46 in close contact therewith (step S-14).

Next, the index table 50 is rotated by 90 degrees (step S-16) and the holder unit 22 is positioned at a magnetic transfer step position 84 in the next step. Then, the coil units 32, 32 are moved to both sides of the holder unit 22 (step S-18) and a magnetic field is applied from both sides thereof while rotating the holder unit 22 (step S-20). In this way, a magnetic information pattern of the master disks 46, 46 is magnetically transferred to both sides of the slave disk 40.

After the magnetic transfer, the coil units 32, 32 are retracted to their initial positions (step S-22), the index table 50 is rotated by 90 degrees and the holder unit 22 is positioned at the disk ejection step position 86 in the next step (step S-24).

Next, the moving side holder 24 is moved so as to go away from the fixed side holder 23 (step S-26). At this time, the magnetically transferred slave disk 40 is suctioned to the inside of the fixed side holder 23 in the same way as when the disk is supplied.

Next, the mirror 18 of the inspection device is moved to a position between the two master disks 46, 46 inside the holder unit 22, the CCD camera 16 and illumination device 17 are adjusted to their appropriate positions, the master disk 46 is inspected for attachment and information on the parts to be inspected (defect (contamination) and position information thereof) is stored in the control device 30A (step S-28).

When the control device 30A decides that the result of the inspection for attachment is acceptable (OK), the process moves to the next step (step S-30) in a normal flow and when the control device 30A decides that the result is not acceptable (NG), the process moves to a cleaning step (master cleaning) by the cleaning device (step S-40).

In the cleaning step (step S-40), the mirror 18 of the inspection device is retracted from between the two master disks 46, 46 inside the holder unit 22 and the air nozzle 19 and suction nozzle 20 are moved to predetermined positions between the two master disks 46, 46 inside the holder unit 22.

The air nozzle 19 then jets out clean air with vibration, sweeps away foreign matters on the master disk 46 and the suction nozzle 20 suctions the air of a sprayed high-pressure jet flow and foreign matters on the master disk 46. In this way, defects (contamination) on the master disk 46 are selectively (locally) removed.

Next, the mirror 18 of the inspection device is moved to a position between the two master disks 46, 46 inside the holder unit 22, the CCD camera 16 and illumination device 17 are adjusted to their appropriate positions and the master disk 46 is reinspected for attachment (step S-44).

When the control device 30A decides that the result of the reinspection for attachment is acceptable (OK), the process moves to the next step (step S-30) in a normal flow and when the control device 30A decides that the result is not acceptable (NG) (e.g., errors are detected at the same region consecutively), the automatic operation is stopped, the contaminated master disk 46 is replaced with a new master disk 46 and the contaminated master disk 46 is subjected to off-line cleaning (step S-46).

When the contaminated master disk 46 is subjected to off-line cleaning, information on defects (attachment) can be output as position information from the inspection apparatus to an off-line cleaner through LAN or the like. Furthermore, it is also possible to provide positioning holes or marks for the master disk 46 beforehand so that the on-line position matches the off-line position.

For off-line cleaning of the master disk 46, it is possible to use liquid cleaning with megasonic vibration using an ultrasonic cleaning head, ultrasonic vibration cleaning of a washing tank in a liquid or the air using an ultrasonic excitation head, electrolytic degreasing cleaning, spraying of gas with ultrasonic vibration, glide cleaning using a glide head having a greater width than a track width, ultrasonic cleaning after glide cleaning, burning cleaning through irradiation of an excimer laser and plasma cleaning or the like.

It is preferable to conduct glide cleaning with an amount of floating of the glide head set to 40 nm or less. Furthermore, overall cleaning of the above described master disk 46 may be performed before a new master disk 46 is set in the magnetic transfer apparatus 10.

In the normal flow, in the next step (step S-30), the chuck 52 of the disk ejection unit 34 is inserted between the fixed side holder 23 and moving side holder 24 and holds the inner diameter of the slave disk 40. By stopping the suction of the slave disk 40 by the fixed side holder 23 and causing the X-axis robot 35 of the disk ejection unit 34 to move the chuck 52 of the disk ejection unit 34, the slave disk 40 is separated from the master disk 46 of the fixed side holder 23.

Next, while the slave disk 40 is held by the chuck 52 of the disk ejection unit 34, the Y-axis robot 36 retracts the disk from the gap of the open holder unit 22 in the Y-axis direction. The rotary cylinder 54 rotates the disk by 180 degrees within the Y-Z plane along an arc path passing outside the apparatus so as to put the disk including the chuck 52 upside down.

Next, the slave disk 40 and chuck 52 are moved to a position above the ejection cassette 56 by the X, Y, Z robots 35, 36, 37 of the disk ejection unit 34 and the slave disks 40 are accommodated in the ejection cassette 56 one by one.

The above described series of operations can be performed by processing their respective steps simultaneously by positioning the holder unit 22 at their respective step positions while intermittently rotating the index table 50 sequentially.

Next, an inspection device which inspects a contamination condition of the slave disk 40 and a cleaning device which selectively cleans contaminated parts on the surface of the slave disk 40 inspected by this inspection device, which are characteristic parts of the present invention will be explained (second embodiment). This inspection device is constructed of a surface inspection device which inspects a contamination condition of the surface of the slave disk 40 and an end face inspection device which inspects a contamination condition of the end face of the slave disk 40.

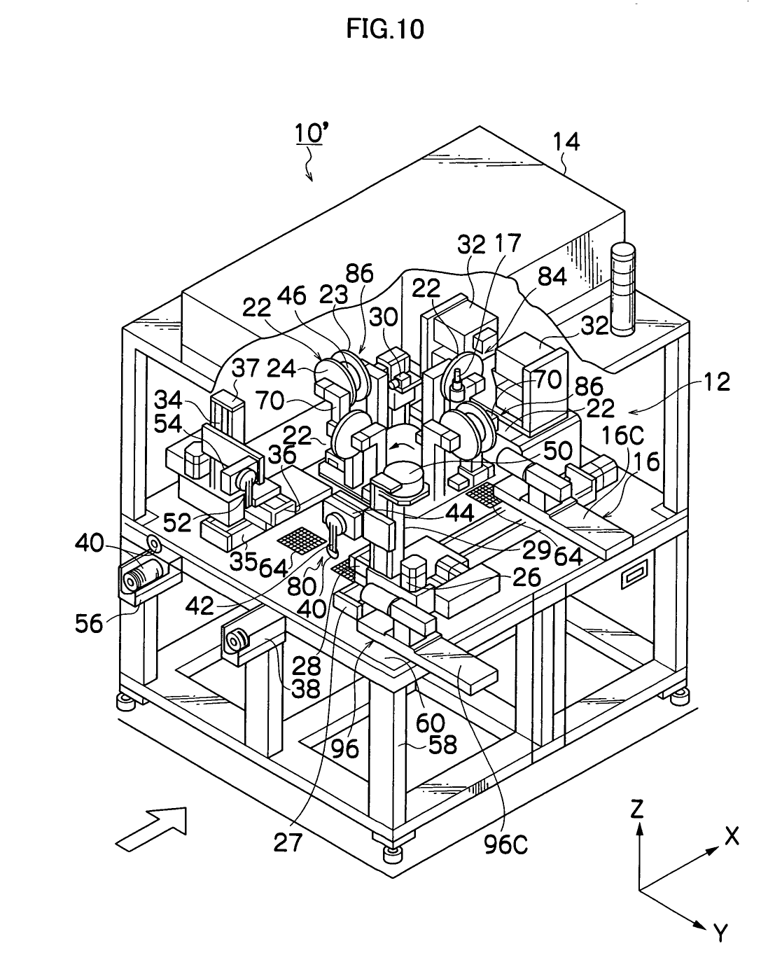

First, the surface inspection device will be explained. FIG. 10 is a partially exploded perspective view of the magnetic transfer apparatus according to the present invention. This magnetic transfer apparatus 10′ has substantially the same structure as that of the magnetic transfer apparatus 10 in FIG. 1. Therefore, the components identical or similar to those of the magnetic transfer apparatus 10 in FIG. 1 are assigned the same reference numerals and detailed explanations thereof will be omitted.

What the magnetic transfer apparatus 10′ differs from the magnetic transfer apparatus 10 in FIG. 1 is in that an index table 50 rotates counterclockwise. (The magnetic transfer apparatus 10 rotates clockwise.) Therefore, the arrangement in horizontal direction of a supply cassette 38 and an ejection cassette 56 is opposite to that in FIG. 1.

A surface inspection device is provided on one side of a chuck mechanism 42 supported by a rotary cylinder 44. In FIG. 10, only a CCD camera 96, an image pickup element, out of the surface inspection device is illustrated and no illumination device 97 or mirror 98 constituting a light irradiation device is illustrated.

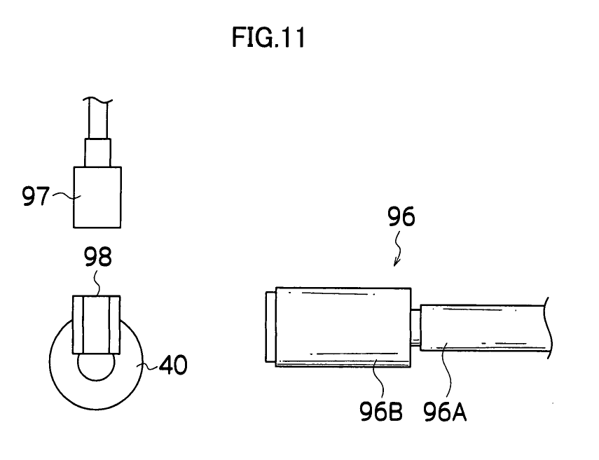

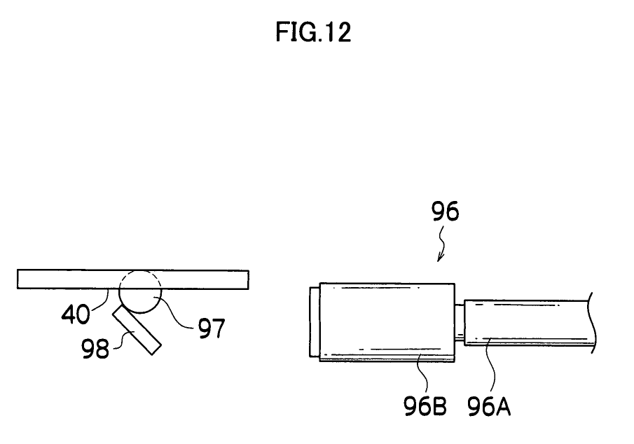

FIG. 11 is a front view showing a positional relationship between the surface inspection device and a slave disk 40 and FIG. 12 is a plan view of the same. This surface inspection device is constructed of a CCD camera 96 which is an image pickup element, an illumination device 97 and a mirror 98. The CCD camera 96 is constructed of a camera body 96A and a lens barrel 96B. This CCD camera 96 is connected to the above described control device 30A.

The CCD camera 96 is supported by a support device 96C (see FIG. 10) and made slightly rotatable around the X-axis and Z-axis according to an instruction from the control device 30A so as to keep track of parts to be inspected on both surfaces of the slave disk 40.

Moreover, the CCD camera 96 is made retractable so as not to interfere with respective robots 27, 28, 29 of a disk ejection unit 26 when an inspection ends. For this CCD camera 96, one similar to the above described CCD camera 16 can be used. Therefore, detailed explanations of the CCD camera 96 will be omitted.

The illumination device 97 is intended to diagonally illuminate the surface of the slave disk 40 whose inner diameter is held by the chuck mechanism 42. As such an illumination device 97, one similar to the above described illumination device 17 can be used. Therefore, detailed explanations of the illumination device 97 will be omitted.

The mirror 98 is made movable by a support device (not shown) so as to keep track of parts to be inspected on both sides of the slave disk 40. Furthermore, the mirror 98 is made retractable so as not to interfere with the respective robots 27, 28, 29 of the disk supply unit 26 when the inspection of the slave disk 40 ends.

This mirror 98 is disposed inclined with respect to the surface of the slave disk 40 and an image of the part to be inspected of the slave disk 40 is disposed at a position at which it can be taken by the CCD camera 96 through the mirror 98.

Both surfaces of this mirror 98 are mirror finished and the mirror 98 is made slightly rotatable around the Z-axis according to an instruction from the control device 30A so as to keep track of parts to be inspected of both sides of the slave disk 40.

The size of the mirror 98 is preferably a size appropriate to the lens used for the lens barrel 96B of the CCD camera 96 (equivalent to the lens diameter). Moreover, the mirror 98 is preferably a high precision surface reflecting mirror. The surface accuracy of the mirror 98 is preferably a ¼ wavelength or less or more preferably a 1/10 wavelength or less.

An inspection is carried out using the surface inspection device at a position different from the position shown in FIG. 10 (e.g., position at which the surface of the slave disk 40 whose inner diameter is held by the chuck mechanism 42 orients the Y-axis direction) or if the CCD camera 96 has a structure movable to a position not interfering with the respective robots 27, 28, 29 of the disk supply unit 26, it is also possible to adopt a structure without any mirror 98 whereby the CCD camera 96 can directly take images of the parts to be inspected of the slave disk 40.

The above described structure of the inspection device allows the surface of the slave disk 40 to be inspected. Information on parts to be inspected of the slave disk 40 whose images have been taken by the CCD camera 96 (defects (contamination) and positional information thereof) is stored in the above described control device 30A.

Next, the end face inspection device and cleaning device will be explained. An end face inspection device and a cleaning device are provided on one side of the holder unit 22 of a disk supply step position 82 in FIG. 10. FIG. 10 only illustrates the CCD camera 16 which is an image pickup element and the illumination,device 17 which is a light irradiation device out of the end face inspection device and the cleaning device is not shown because it is retracted to the opposite side of the holder unit 22.

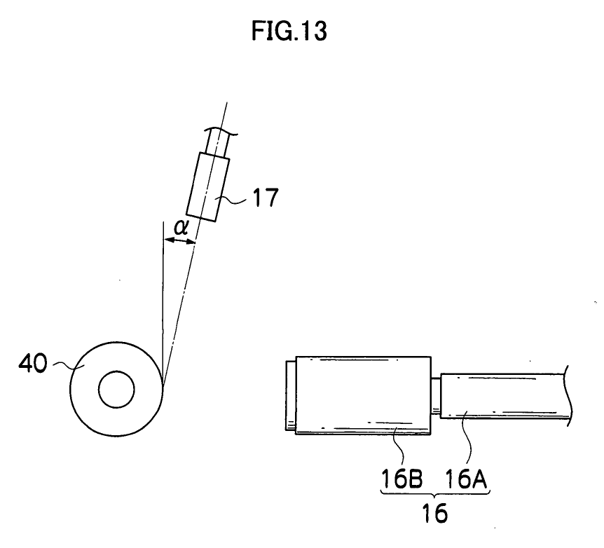

FIG. 13 is a front view showing a positional relationship between the end face inspection device and the slave disk 40. This end face inspection device is constructed of the CCD camera 16 which is an image pickup element and the illumination device 17. The CCD camera 16 is constructed of a camera body 16A and a lens barrel 16B. This CCD camera 16 is connected to the above described control device 30A.

As the CCD camera 16 and illumination device 17 used for this end face inspection device, ones similar to the CCD camera 96 and illumination device 97 used for the above described surface inspection device can be used. Therefore, detailed explanations of the CCD camera 16 and illumination device 17 will be omitted.

The CCD camera 16 is supported by a support device 16C (see FIG. 10) and made slightly rotatable around the X-axis and Z-axis according to an instruction from the control device 30A so as to keep track of parts to be inspected of the slave disk 40.

Moreover, the CCD camera 16 is made retractable so as not to interfere with the respective robots 27, 28, 29 of the disk supply unit 26 when an inspection ends.

The illumination device 17 is supported by a support device (not shown) and made slightly rotatable around the X-axis and Z-axis according to an instruction from the control device 30A so as to keep track of parts to be inspected (end face) of the slave disk 40.

The illumination device 17 is supported so that the optical axis thereof forms an angle α with respect to the tangential direction of parts to be inspected on the end face of the slave disk 40. This angle α preferably ranges from 0 to 20 degrees and more preferably ranges from 5 to 15 degrees. Furthermore, the illumination device 17 is preferably supported so that the optical axis thereof forms an angle of ±5 degrees with respect to the surface of the slave disk 40.

When the entire perimeter of the end face of the slave disk 40 is inspected, images can be taken by the CCD camera 16 while the slave disk 40 is being rotated at a constant speed by the holder unit 22.

In this case, when the end face of the inner/outer perimeter of the slave disk 40 is inspected, the CCD camera 16 is focused on any one of the inner/outer end faces, images of the entire perimeter of this end face are taken and then the CCD camera 16 is focused on the other end face and images of the entire perimeter of this end face can be taken.

When inspecting parts of the end face of the slave disk 40 particularly vulnerable to contamination, more specifically two parts of the outer perimeter which contacts the grooves 92 of the disk supply cassette 38, it is also possible to rotate the slave disk 40 intermittently by the holder unit 22 and only take images of the parts using the CCD camera 16. Furthermore, it is also possible to adopt a structure in which a plurality of CCD cameras 16 and illumination devices 17 are provided so as to inspect parts of the disk which contact the grooves 92 of the disk supply cassette 38 without rotating the slave disk 40.

The above described structure of the inspection device allows the end face of the slave disk 40 to be inspected. Information on parts to be inspected of the slave disk 40 whose images have been taken by the CCD camera 16 (defects (contamination) and positional information thereof) is stored in the above described control device 30A.

As the cleaning device, one similar to that described above in FIG. 8 can be used. Therefore, explanations of the structure of the cleaning device will be omitted. This cleaning device can selectively (locally) remove defects (contamination) of the slave disk 40 according to information (defect (contamination) and position information thereof) on parts to be inspected stored in the control device 30A.

The cleaning device can also be provided at a position at which the slave disk 40 is inspected by the surface inspection device in addition to the position at which the slave disk 40 is inspected by the end face inspection device.

Next, the method of operating the magnetic transfer apparatus in the above described structure will be explained. The cleaning device is also provided at a position at which the slave disk 40 is inspected by the surface inspection device in addition to the above described position (position at which the slave disk 40 is inspected by the end face inspection device).

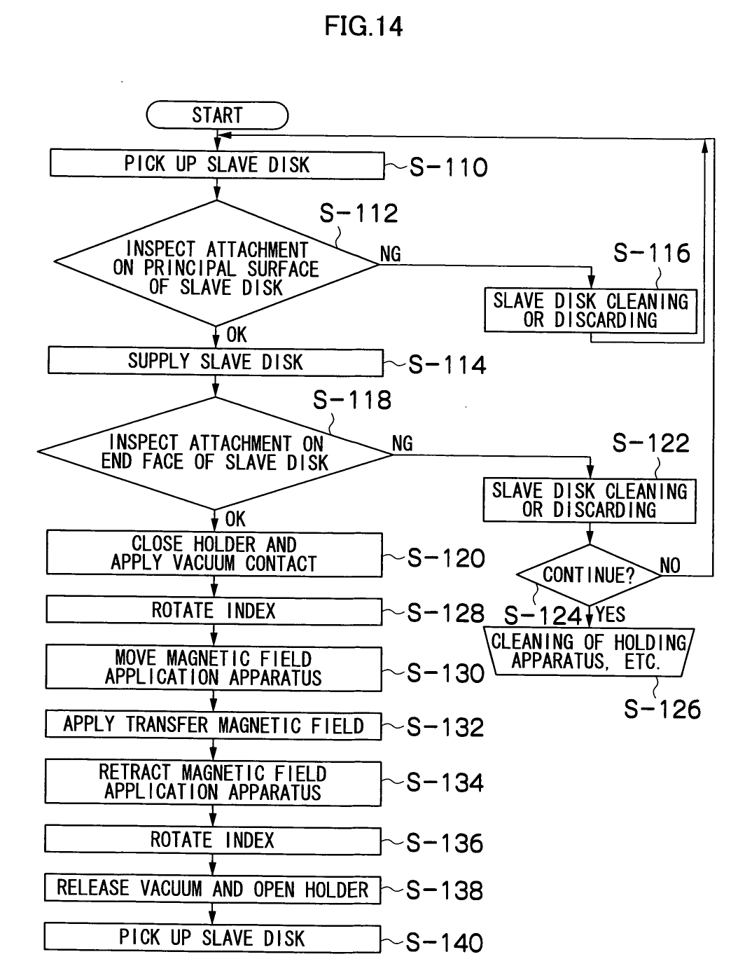

FIG. 14 is a flow chart illustrating the method of operating the magnetic transfer apparatus.

When the operation is started, the chuck mechanism 42 (chucks 42a, 42b) of the disk supply unit 26 holds the slave disk 40 inside the disk supply cassette 38 and picks up the disks one by one (step S-110).

The slave disk 40 picked up remains held at an inspection position 80 shown in FIG. 10.

Next, the mirror 98 of the inspection device shown in FIG. 11 and FIG. 12 is moved to a position facing the slave disk 40, the positions of the CCD camera 96 and the illumination device 97 are adjusted to their appropriate positions, the slave disk 40 is inspected for attachment, information on parts to be inspected (defect (contamination) and position information thereof) is stored in the control device 30A and the control device 30A decides whether the result of attachment inspection is acceptable or not (step S-112).

When the control device 30A decides that the result of the attachment inspection is acceptable (OK), the process moves to the next step (step S-114) of a normal flow and when the control device 30A decides that the result is not acceptable (NG), the process moves to a cleaning step (step S-116) by a cleaning device.

In the cleaning step (step S-116), the mirror 98 of the inspection device is retracted from the neighborhood of the slave disk 40 and the air nozzle 19 and suction nozzle 20 are moved to predetermined positions in the vicinity of the slave disk 40.

The air nozzle 19 jets clean air with vibration, removes foreign matters on the surface of the slave disk 40 and the suction nozzle 20 suctions the air of the sprayed high-pressure jet flow and foreign matters on the surface of the slave disk 40. In this way, defects (contamination) on the surface of the slave disk 40 are selectively (locally) removed.

In this step S-116, the slave disk 40 for which the cleaning step has been completed is reinspected at the same position (step S-112).

When the control device 30A decides in step S-112 that the result is not acceptable (NG) and the cleaning step has already been completed, the slave disk 40 is discarded. More specifically, the disk supply unit 26 accommodates the slave disk 40 in a discarding cassette (not shown) provided inside the apparatus body 12. This discarding cassette is ejected out of the apparatus body 12 when a predetermined number (e.g., 25) of slave disks 40 to be discarded are accommodated.

In step S-114, the slave disks 40 whose surface inspection has been completed are turned over within the Y-Z plane through the rotation of the rotary cylinder 44 and then moved by the X-axis robot 27 to an upper part of a gap between the master disks 46, 46 formed of the opened holder unit 22 arranged at a disk supply step position 82 in a direction perpendicular to the opening/closing direction of the holder unit 22 and inserted into a gap between the master disks 46, 46 by the Y-axis robot 28.

At this time, the respective master disks 46, 46 are accurately fixed to positions at which the center of the holder unit 22 matches the center of the master disk 46 under suction or adhesion inside the fixed side holder 23 and moving side holder 24 of the holder unit 22 according to an off-line setup or the like beforehand.

The center of the slave disk 40 supplied between the fixed side holder 23 and moving side holder 24 of the holder unit 22 substantially matches the center of the master disk 46 fixed to the inside of the fixed side holder 23 by the X, Y, Z-axis robots of the disk supply unit 26 and the slave disk 40 is moved to a recognition position at which the gap with respect to the master disk 46 becomes approximately 0.5 mm.

Next, the reference mark 21A provided on the undersurface of the fixed side holder 23 and the recognition marks 21B, 21B provided beforehand for the chuck mechanism 42 (chucks 42a, 42b) of the disk supply unit 26 are recognized by the recognition unit 30.

This recognition allows the Y-, Z-axis robots 28, 29 of the disk supply unit 26 to position the slave disk 40 so that the center of the master disk 46 calculated from the reference mark 21A matches the center of the slave disk 40 calculated from the recognition marks 21B, 21B of the chuck mechanism 42.

Next, the slave disk 40 is moved by the X-axis robot 27 of the disk supply unit 26 to a position in close contact with the master disk 46 fixed to the inside of the fixed side holder 23 and suctioned and fixed to the inside of the fixed side holder 23 (step S-114).

Next, the CCD camera 16 and illumination device 17 of the end face inspection device are adjusted to their appropriate positions, the slave disk 40 is inspected for attachment and information on the parts to be inspected (defect (contamination) and position information thereof) is stored in the control device 30A and the control device 30A decides whether the result of the attachment inspection is acceptable or not (step S-118).

When the control device 30A decides that the result of the inspection for attachment is acceptable (OK), the process moves to the next step (step S-120) in a normal flow and when the control device 30A decides that the result is not acceptable (NG), the process moves to a cleaning step by the cleaning device (step S-122).

In the cleaning step (step S-122), the air nozzle 19 and suction nozzle 20 are moved to predetermined positions between the slave disk 40 held by the fixed side holder 23 of the holder unit 22 and the master disks 46 held by the moving side holder 24.

The air nozzle 19 then jets out clean air with vibration, sweeps away foreign matters on the end face of the slave disk 40 and the suction nozzle 20 suctions the air of a sprayed high-pressure jet flow and foreign matters on the end face of the slave disk 40. In this way, defects (contamination) on the slave disk 40 are selectively (locally) removed.

In step S-122, when the control device 30A decides that the result is not acceptable (NG) and the cleaning step has already been completed, the slave disk 40 is discarded. More specifically, the disk supply unit 26 accommodates the slave disk 40 in a discarding cassette (not shown) provided inside the apparatus body 12.

Next, the control device 30A decides whether the immediately preceding slave disk 40 has also been subjected to the cleaning step (cleaning step continues) or not (step S-124) and if it continues (Yes), it stops the normal operation and proceeds to cleaning of the holding apparatus such as the chuck mechanism 42 (step S-126).

On the other hand, when the cleaning step does not continue (No) in step S-124, the slave disk 40 is carried by the X, Y, Z-axis robots of the disk supply unit 26 to an inspection position (position of the surface inspection device) 80, turned over within the Y-Z plane through the rotation of the rotary cylinder 44 and reinspected by the surface inspection device (step S-112).

In the next step of a normal flow (step S-120), the moving side holder 24 is moved by the robot 70 toward the fixed side holder 23 so as to interpose both sides of the slave disk 40 between the two master disks 46, 46. In this way, both sides of the slave disk 40 are interposed between the two master disks 46, 46 in close contact therewith (step S-120).

Next, the index table 50 is rotated by 90 degrees (step S-128) and the holder unit 22 is positioned at the magnetic transfer step position 84 in the next step. Then, the coil units 32, 32 are moved to both sides of the holder unit 22 (step S-130) and a magnetic field is applied from both sides thereof while rotating the holder unit 22 (step S-132). In this way, a magnetic information pattern of the master disks 46, 46 is transferred to both sides of the slave disk 40.

After the magnetic transfer, the coil units 32, 32 are retracted to their initial positions (step S-134), the index table 50 is rotated by 90 degrees and the holder unit 22 is positioned at the disk ejection step position 86 in the next step (step S-136).

Next, the moving side holder 24 is moved so as to go away from the fixed side holder 23 (step S-138). At this time, the magnetically transferred slave disk 40 is suctioned to the inside of the fixed side holder 23 in the same way as when the disk is supplied.

Next, the chuck 52 of the disk ejection unit 34 (see FIG. 2) is inserted between the fixed side holder 23 and moving side holder 24 and holds the inner diameter of the slave disk 40. By stopping the suction of the slave disk 40 by the fixed side holder 23 and moving the chuck 52 of the disk ejection unit 34 using the X-axis robot 35 of the disk ejection unit 34, the slave disk 40 is separated from the master disk 46 in the fixed side holder 23.

Next, while the slave disk 40 is held by the chuck 52 of the disk ejection unit 34, the Y-axis robot 36 retracts the disk from the gap of the open holder unit 22 in the Y-axis direction. The rotary cylinder 54 rotates the disk by 180 degrees within the Y-Z plane along an arc path passing outside the apparatus so to put the disk including the chuck 52 upside down.

Next, the slave disk 40 and chuck 52 are moved to a position above the ejection cassette 56 by the X, Y, Z robots 35, 36, 37 of the disk ejection unit 34 and the slave disks 40 are accommodated in the ejection cassette 56 one by one (step S-140).

The above described series of operations can be performed by processing their respective steps simultaneously by positioning the holder unit 22 at their respective step positions while intermittently rotating the index table 50 sequentially.

The embodiments of the magnetic transfer method, apparatus and method of inspecting the master disk have been explained so far, but the present invention is not limited to the above described embodiments and can take various modes.

For example, in the first embodiment, after a new master disk 46 is set, dust with still weak adhesion may be stuck when the disk is stored or set, and therefore it is preferable to apply total cleaning with relatively high pressure air before carrying out a transfer.

Then, in step S-28, an initial inspection is carried out to register non-defect pattern reflection and initial defects that have no influence on the quality such as micro depressions outside the pattern. Based on this data, only an increase from the initial phase of the inspection after the transfer is targeted and excessive detection is suppressed. This allows also the pattern to be used as a base for floating point binarization and also allows an excessive inspection to be suppressed.

Furthermore, in the first embodiment, the attachment inspection of the master disk 46 and the ejection of the slave disk 40 are carried out at the same step position (disk ejection step position 86 in FIG. 10), but these may be carried out in different step positions.

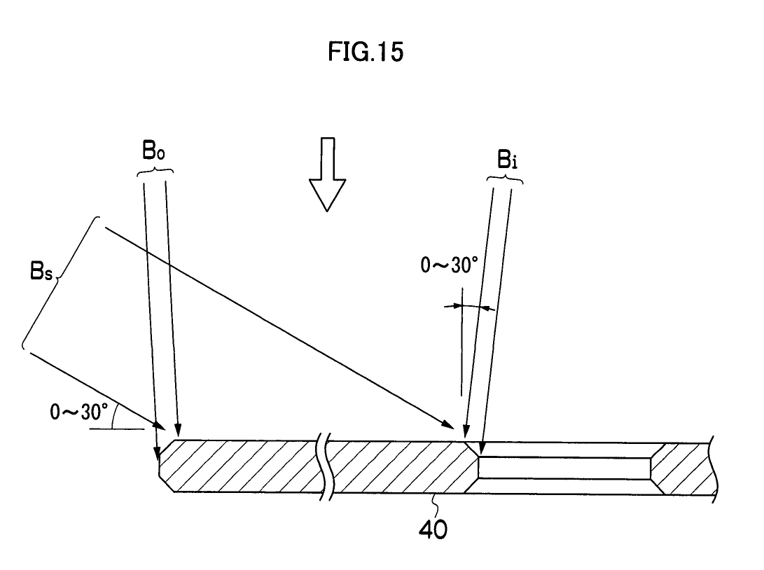

Furthermore, in the second embodiment, the inspection device consists of two types of devices; the surface inspection device and end face inspection device, but a surface inspection and an end face inspection of the slave disk 40 may be performed using one inspection device. FIG. 15 is a partially enlarged sectional view showing this structure.

In FIG. 15, different illumination devices are provided for the surface and end face of the slave disk 40, and illumination of the surface of the slave disk 40 is carried out using a beam Bs, illumination of the end face of the outer perimeter of the slave disk 40 is carried out using a beam Bo and illumination of the end face of the inner perimeter of the slave disk 40 is carried out using a beam Bi.

In this case, the angle of inclination of the beam Bs with respect to the surface of the slave disk 40 is preferably set to 0 to 30 degrees, while the angles of inclination of the beam Bo and beam Bi with respect to the normal to the surface of the slave disk 40 are preferably set to 0 to 30 degrees.

Then, images can be taken using a line sensor from the direction indicated by a thick arrow in FIG. 14. A lens for a telecentric optical system is preferably used for a lens (not shown) of the line sensor to make sure images reflected on the vertical plane (not tapered plane) of the end face of the outer perimeter and end face of the inner perimeter are taken.

Moreover, the foregoing embodiments have explained transfers of magnetic disks, but the present invention is applicable not only to transfers of magnetic disks but also to transfers of various types of media such as optical disk (including magneto-optical disk).

Furthermore, the structure of the magnetic transfer apparatus 10 is not limited to the rotary index system in the above described embodiment, but various types such as an in-line index system can be used.

### Embodiment

Using the magnetic transfer apparatus 10, the master disk 46 was inspected for attachment. In this case, as an embodiment of the present invention, the inspection device (CCD camera 16, illumination device 17 and mirror 18) shown in FIG. 5 to FIG. 7 was used. As the illumination device 17, a 250 W metal halide light source, fiber and condensing lens and an infrared cut filter were used.

The illumination device 17 was adjusted so that the optical axis thereof formed an angle of 3 degrees with respect to the radial direction of parts to be inspected on the surface of the master disk 46. More specifically, the illumination device 17 was adjusted so that the angle of inclination with respect to the surface (plane) of the disk was 3 degrees and the angle of inclination with respect to the radius of the surface (plane) of the disk was 0 degrees.

As a comparative example, the inspection device (CCD camera 16 and mirror 18) shown in FIGS. 5 to 7 was used likewise. However, instead of the illumination device 17, a 150 W halogen lamp, fiber and condensing lens and an infrared cut filter were used. Then, this light source was adjusted so that the optical axis thereof formed an angle of 45 degrees with respect to the radial direction of parts to be inspected of the surface of the master disk 46.

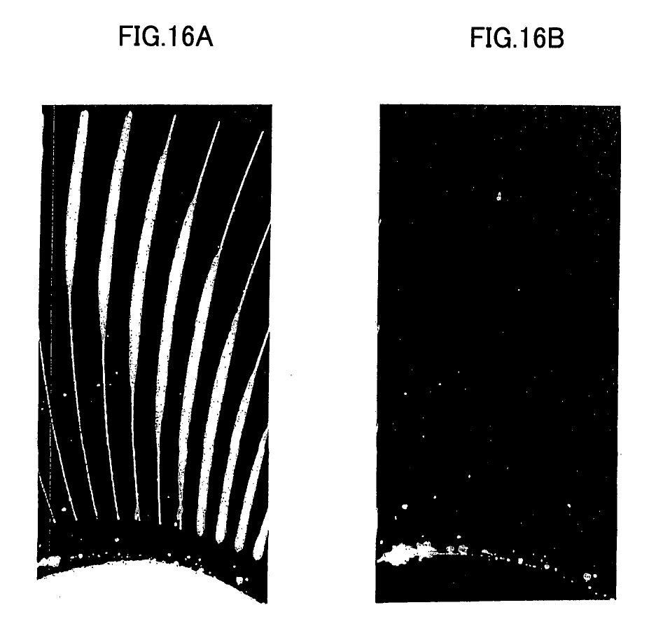

FIG. 16 is an example of an image taken by the CCD camera 16. FIG. 16A shows a result of the comparative example and FIG. 16B shows a result of the embodiment.

In FIG. 16A, a protruding magnetic layer pattern showed high reflectivity in a line shape, and therefore it is understandable that saturation occurred and the CCD charge leaked up to the periphery of the pattern.

On the other hand, in FIG. 16B, it is understandable that the intensity of the attachment did not change and the intensity of the protruding magnetic layer pattern decreased sufficiently.

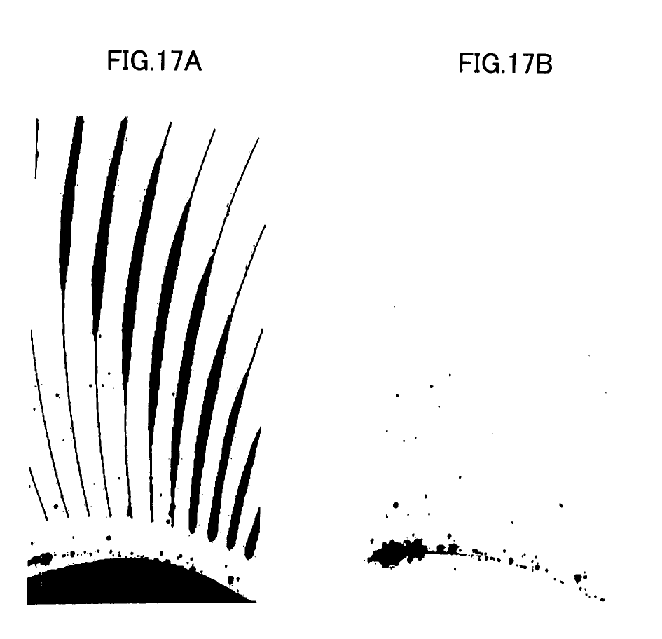

FIG. 17 is an image after binarizing the image of FIG. 16. FIGS. 17A and 17B correspond to FIGS. 16A and 16B respectively.

In the comparative example in FIG. 17A, the CCD charge leaked up to the periphery of the pattern even after binarization. Therefore, in the comparative example, the pattern cannot help but be masked and there is a potential for many attachments to be overlooked.

On the other hand, in the embodiment in FIG. 17B, it is understandable that only attachments were detected after the binarization.

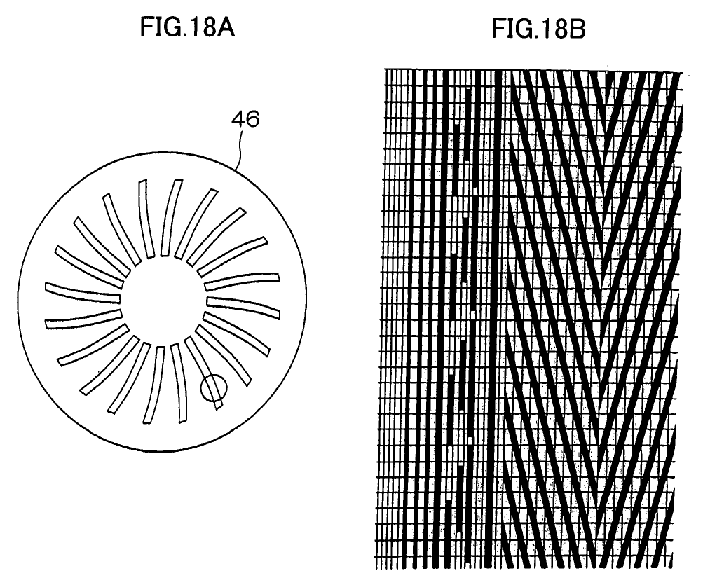

FIG. 18 shows a master disk 46 used for the above described attachment inspection, FIG. 18A shows a measured region and FIG. 18B shows an enlarged view of the part encircled in FIG. 18A.

What is claimed is:

1. A transfer apparatus comprising:
a disk holding device which holds a master disk having many protruding patterns formed on the surface thereof by a holder section;
a transfer device which transfers a pattern of the master disk to a slave disk; and
an inspection device which causes a light irradiation device to irradiate irradiation light in such a way that the optical axis of the irradiation light forms an angle of 0 to 30 degrees with respect to a radial direction in parts to be inspected on the surface of the master disk, causes an image pickup element to take images of reflected light of the light irradiated and inspects a contamination condition on the surface of the master disk.

2. A transfer apparatus comprising:
a disk holding device which holds a master disk having many protruding magnetic layer patterns formed on the surface thereof by a holder section;
a magnetic field application device which applies a magnetic field to the holder section and transfers a magnetic pattern of the master disk to a slave disk; and
an inspection device which causes a light irradiation device to irradiate irradiation light in such a way that the optical axis of the irradiation light forms an angle of 0 to 30 degrees with respect to a radial direction in parts to be inspected on the surface of the master disk, causes an image pickup element to take images of reflected light of the light irradiated and inspects a contamination condition on the surface of the master disk.

3. The transfer apparatus according to claim 1, further comprising a cleaning device which selectively cleans contaminated parts on the surface of the master disk inspected by the inspection device.

4. The transfer apparatus according to claim 2, further comprising a cleaning device which selectively cleans contaminated parts on the surface of the master disk inspected by the inspection device.

5. The transfer apparatus according to claim 1, further comprising:
a supply device which supplies a slave disk in such a way as to face the master disk held by the holder section; and
a drive device which activates the holding device to pressure-contact the master disk against the slave disk.

6. The transfer apparatus according to claim 2, further comprising:
a supply device which supplies a slave disk in such a way as to face the master disk held by the holder section; and
a drive device which activates the holding device to pressure-contact the master disk against the slave disk.

7. The transfer apparatus according to claim 3, further comprising:
a supply device which supplies a slave disk in such a way as to face the master disk held by the holder section; and
a drive device which activates the holding device to pressure-contact the master disk against the slave disk.

8. The transfer apparatus according to claim 4, further comprising:
a supply device which supplies a slave disk in such a way as to face the master disk held by the holder section; and
a drive device which activates the holding device to pressure-contact the master disk against the slave disk.

9. A transfer method comprising:
a supply step of supplying a slave disk in such a way as to face a master disk held in a holder section with many protruding magnetic layer patterns formed on the surface thereof;
a pressure contacting step of pressure-contacting the supplied slave disk interposed between the master disks;
a transfer step of applying a magnetic field to the holder section and transferring magnetic patterns on the master disk to the slave disk; and
an inspection step of causing a light irradiation device to irradiate irradiation light in such a way that the optical axis of the irradiation light forms an angle of 0 to 30 degrees with respect to a radial direction in parts to be inspected on the surface of the master disk, causing an image pickup element to take images of reflected light of the light irradiated and inspecting a contamination condition on the surface of the master disk.

10. A method of inspecting a master disk comprising the steps of supplying a slave disk in such a way as to face a master disk with many protruding magnetic layer patterns formed on the surface thereof and inspecting a contamination condition on the surface of the master disk used to transfer the patterns of the master disk to the slave disk,
wherein a light irradiation device irradiates irradiation light in such a way that the optical axis of the irradiation light forms an angle of 0 to 30 degrees with respect to a radial direction in parts to be inspected on the surface of the master disk and an image pickup element takes images of reflected light of the light irradiated and inspects a contamination condition on the surface of the master disk.

11. A transfer apparatus comprising:
a transfer device which transfers patterns of a master disk to a slave disk; and
an inspection device which inspects a contamination condition of the surface and end face of the slave disk.

12. A transfer apparatus comprising:
a disk holding device which holds a master disk having magnetic patterns by a holder section;
an inspection device which inspects a contamination condition of the surface and end face of a slave disk;
a supply device which supplies the slave disk in such a way as to face the master disk held by the holder section; and
a magnetic field application device which applies a magnetic field to the holder section and transfers the magnetic patterns of the master disk to the slave disk.

13. The transfer apparatus according to claim 11, further comprising a cleaning device which selectively cleans contaminated parts on the surface and/or end face of the slave disk inspected by the inspection device.

14. The transfer apparatus according to claim 12, further comprising a cleaning device which selectively cleans contaminated parts on the surface and/or end face of the slave disk inspected by the inspection device.

15. The transfer apparatus according to claim 13, further comprising:
a decision device which decides a contamination condition of the slave disk inspected by the inspection device; and
a selection device which selects, based on the decision result from the decision device, a first option of carrying out a magnetic transfer using the magnetic field application device, a second option of carrying out cleaning of the slave disk using the cleaning device and a third option of ejecting the slave disk out of the apparatus without passing through the magnetic field application device and/or the cleaning device.

16. The transfer apparatus according to claim 14, further comprising:
a decision device which decides a contamination condition of the slave disk inspected by the inspection device; and
a selection device which selects, based on the decision result from the decision device, a first option of carrying out a magnetic transfer using the magnetic field application device, a second option of carrying out cleaning of the slave disk using the cleaning device and a third option of ejecting the slave disk out of the apparatus without passing through the magnetic field application device and/or the cleaning device.

17. The transfer apparatus according to claim 13, wherein the inspection device comprises: a surface inspection device which inspects a contamination condition of the surface of the slave disk; and an end face inspection device which inspects a contamination condition of the end face of the slave disk.

18. The transfer apparatus according to claim 14, wherein the inspection device comprises: a surface inspection device which inspects a contamination condition of the surface of the slave disk; and an end face inspection device which inspects a contamination condition of the end face of the slave disk.

19. A transfer method comprising:
an inspection step of inspecting a contamination condition of the surface and end face of a slave disk;
a selection step of selecting the slave disk into rank A and rank B based on the inspection result in the inspection step;
a supply step of supplying the slave disk of rank A in such a way as to face a master disk held by a holder section and having magnetic patterns;
a pressure contacting step of pressure-contact the supplied slave disk interposed between the master disks;
a transfer step of applying a magnetic field to the holder section and transferring magnetic patterns on the master disk to the slave disk; and
a reproduction step of cleaning or discarding the slave disk of rank B.
